(19) United States
(12) Patent Application Publication
(10) Pub. No.: US 2021/0224908 A1
(43) Pub. Date: Jul. 22, 2021

(54) SYSTEMS AND METHODS FOR NEGOTIATION OF SUBOPTIMAL SAVINGS

(71) Applicant: Wells Fargo Bank, N.A., San Francisco, CA (US)

(72) Inventors: Wayne Barakat, Novato, CA (US); Thomas E. Gross, San Anselmo, CA (US); Darius Miranda, San Francisco, CA (US); Marria Wairmola Rhodriquez, San Francisco, CA (US); Andres J. Saenz, Redmond, WA (US); Sadie Salim, Albany, CA (US); Duc M. Trinh, Golden Valley, MN (US)

(21) Appl. No.: 15/612,661

(22) Filed: Jun. 2, 2017

Related U.S. Application Data
(60) Provisional application No. 62/491,073, filed on Apr. 27, 2017.

(51) Int. Cl. G06Q 40/06; G06Q 20/14

(52) U.S. Cl. CPC G06Q 40/06; G06Q 20/14

(57) ABSTRACT

Systems, methods, and apparatuses for negotiating a suboptimal savings plan include a financial strategy database storing information associated with an optimal savings plan and at least one suboptimal savings plan, an account information database storing information associated with a financial account held by a customer, and a processing circuit. The processing circuit is structured to identify an opportunity for a suboptimal savings plan relating to the customer, receive information associated with a financial account held by the customer, generate a set of potential suboptimal savings plans based on the received information, provide the customer with the set of potential suboptimal savings plans, and set an accepted suboptimal savings plan as an active savings plan in response to the customer selecting one of the potential suboptimal savings plans.

### CROSS-REFERENCE TO RELATED APPLICATIONS

This application claims the benefit of priority to U.S. Application No. 62/491,073, filed Apr. 27, 2017, entitled “SYSTEMS AND METHODS FOR NEGOTIATION OF SUBOPTIMAL SAVINGS”, which is hereby incorporated by reference in its entirety.

### BACKGROUND

Many consumers have financial goals for the short term and the long term. For example, a consumer may wish to save a certain sum of money by retirement age. To meet a financial goal, the consumer may develop a savings plan, such as saving a set amount of money every month. Successfully meeting the financial goal with the savings plan may depend on various conditions, such as market performance, proper implementation of the savings plan, etc.

### SUMMARY

One embodiment relates to a financial institution computing system. The financial institution computing system includes a network interface enabling the financial institution computing system to exchange information over a network. The financial institution computing system also includes a financial strategy database storing information associated with an optimal savings plan and at least one suboptimal savings plan. The financial institution computing system also includes an account information database storing information associated with a financial account held by a customer. The financial institution computing system also includes a processing circuit. The processing circuit is structured to identify an opportunity for a suboptimal savings plan relating to the customer. The processing circuit is also structured to receive information associated with a financial account held by the customer. The processing circuit is also structured to generate a set of potential suboptimal savings plans based on the received information. The processing circuit is also structured to provide to the customer, via a device of the customer, the set of potential suboptimal savings plans. The processing circuit is also structured to set an accepted suboptimal savings plan as an active savings plan in response to the customer selecting one of the potential suboptimal savings plans.

Another embodiment relates to a method for negotiating a suboptimal savings plan. The method includes identifying, by a financial institution computing system, an opportunity for a suboptimal savings plan relating to a customer. The method also includes receiving, by the financial institution computing system, information associated with a financial account held by the customer. The method also includes generating, by the financial institution computing system, a set of potential suboptimal savings plans based on the received information. The method also includes communicating, by the financial institution computing system, the set of potential suboptimal savings plans with the customer. The method also includes setting, by the financial institution computing system, an accepted suboptimal savings plan as an active savings plan in response to the customer selecting one of the potential suboptimal savings plans.

Another example embodiment relates to a financial strategy management processing circuit included in a financial institution computing system associated with a financial institution. The financial strategy management processing circuit is configured to identify an opportunity for a suboptimal savings plan relating to a customer. The financial strategy management processing circuit is also configured to receive information associated with a financial account held by the customer. The financial strategy management processing circuit is also configured to generate a set of potential suboptimal savings plans based on the received information. The financial strategy management processing circuit is also configured to provide the customer with the set of potential suboptimal savings plans. The financial strategy management processing circuit is also configured to set an accepted suboptimal savings plan as an active savings plan in response to the customer selecting one of the potential suboptimal savings plans.

These and other features, together with the organization and manner of operation thereof, will become apparent from the following detailed description when taken in conjunction with the accompanying drawings.

### BRIEF DESCRIPTION OF THE DRAWINGS

FIG. 1 is a block diagram of a system for negotiation of suboptimal savings, according to an example embodiment.

FIG. 2 is a view of a flow diagram of a method for negotiation of suboptimal savings, according to an example embodiment.

FIG. 3 shows a user interface of a customer device during a process for negotiation of suboptimal savings, according to an example embodiment.

FIG. 4 shows another user interface of a customer device during a process for negotiation of suboptimal savings, according to an example embodiment.

### DETAILED DESCRIPTION

Before turning to the figures which illustrate example embodiments, it should be understood that the application is not limited to the details or methodology set forth in the following description or illustrated in the figures. It should also be understood that the phraseology and terminology employed herein is for the purpose of description only and should not be regarded as limiting. For example, the embodiments of systems and methods discussed herein may be relevant to any of a variety of circumstances where negotiating a suboptimal plan may be useful.

In an example implementation, a customer provides information to the financial institution relating to savings goals, requirements and preferences, and personal interests. The financial institution can develop a set of potential suboptimal savings plans using the provided information and any other information that facilitates development of the set. The set of potential suboptimal savings plans can include several suboptimal savings plans designed to result in various savings balances after a time period. The customer can interact with the financial institution to negotiate and identify an acceptable suboptimal savings plan from the set. The financial institution can also facilitate implementation of the suboptimal savings plan by, for example, monitoring growth of a savings account balance over time.

The embodiments and implementations of the systems and methods disclosed herein improve current financial savings systems by developing an alternate solution to an optimal savings plan and facilitating its implementation. Current systems are generally configured to address a customer's financial goal by developing an optimal savings plan such that a maximum savings is achieved. However, implementation of the optimal solution can often be too difficult for the customer. In turn, the customer may not follow any savings plan, thereby resulting in minimum savings. Systems and methods disclosed herein enable development and facilitate implementation of a suboptimal savings plan, which is a plan designed to not achieve maximum savings or sufficient savings to reach a goal but will more likely be implemented by the customer. Accordingly, systems and methods disclosed herein enable a customer to achieve a financial result that, even though does not achieve maximum savings or sufficient savings to reach a goal, can be significantly better than a current savings plan or other methodology implemented by the customer. As such, the systems, methods, and computer implementations disclosed herein improve current savings methods by providing functionalities that are novel and non-obvious improvements over current systems.

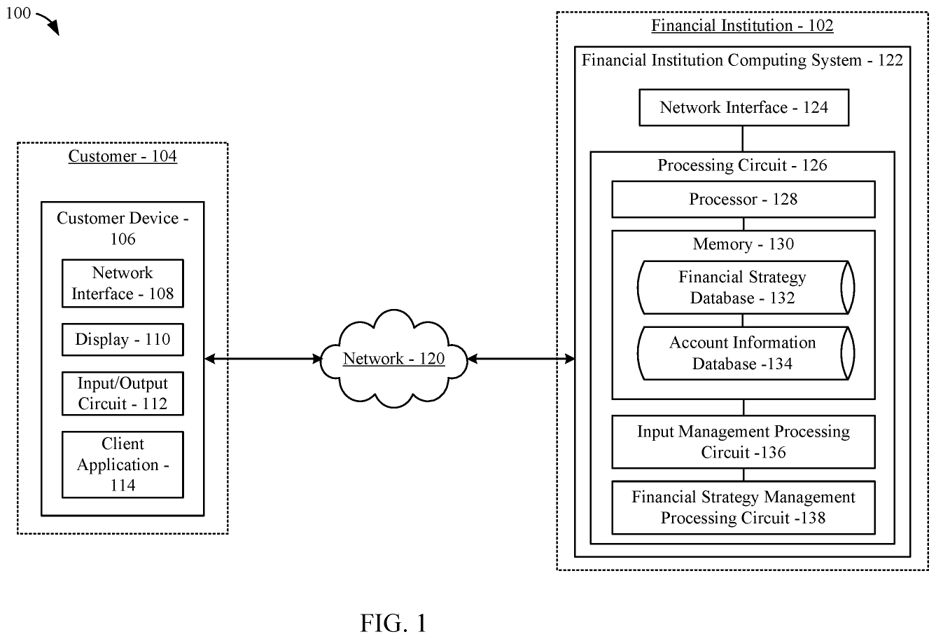

Referring to FIG. 1, a block diagram of a system 100 for negotiating a suboptimal savings plan is shown according to an example embodiment. Generally, the system 100 is configured to facilitate development and implementation of a suboptimal savings plan. In some arrangements, development of suboptimal savings plans includes developing a spectrum of potential suboptimal savings plans, whereby each plan in the spectrum is designed to result in one of several savings balances after a time period. One end of the spectrum can conceptually represent a potential savings balance associated with an optimal savings plan, whereby the potential savings balance is maximized. The other end of the spectrum can conceptually represent a potential savings balance associated with minimal savings. Accordingly, the spectrum of potential suboptimal savings plan can include various suboptimal savings plans, whereby each plan is associated with a potential savings balance after a time period along the spectrum.

System 100 includes a financial institution computing system 122 associated with a financial institution 102, where the financial institution computing system 122 is communicably and operatively coupled to a customer device 106 associated with a customer 104, over a network 120. The network 120 provides communicable and operative coupling between the customer device 106 and the financial institution computing system 122, and other components disclosed and described herein to provide and facilitate the exchange of communications (e.g., data, instructions, messages, values, commands, etc.). Accordingly, the network 120 may include any network including wired (e.g., Ethernet) and/or wireless networks (e.g., 802.11X, ZigBee, Bluetooth, Wi-Fi, etc.). In some arrangements, the network 120 includes the Internet. In further embodiments, the network 120 includes a proprietary banking network to provide secure or substantially secure communications.

The customer device 106 includes any type of computing device that may be used to facilitate communication with financial institution computing system 122 relating to negotiation of a suboptimal savings plan. In some arrangements, the customer 104 uses the customer device 106 for development and implementation of various savings plans associated with a savings goal. For example, financial institution computing system 122 may provide various prompts to customer 104 via customer device 106 for gathering acceptable parameters of potential savings plans. Using customer device 106, customer 104 can respond to financial institution computing system 122. The customer device 106 may include any type of mobile device including, but not limited to, a phone (e.g., smartphone, etc.), and/or any type of computing devices (e.g., desktop computer, laptop computer, personal digital assistant, etc.). The customer device 106 may also include any wearable device, including but not limited to, a watch (e.g., smart watch), glasses (e.g., eye glasses, sunglasses, smart glasses, etc.), bracelet (e.g., a smart bracelet), etc.

The customer device 106 further includes a display 110, an input/output circuit 112, a network interface 108, and a client application 114. The network interface 108 of the customer device 106 is adapted for and configured to establish a communication session via the network 120 with the financial institution computing system 122. Accordingly, the network interface 108 includes any of a cellular transceiver (Code Division Multiple Access (CDMA), Global System for Mobile Communications (GSM), Long-Term Evolution (LTE), etc.), a wireless network transceiver (e.g., 802.11X, ZigBee, Bluetooth, etc.), or a combination thereof (e.g., both a cellular transceiver and a Bluetooth transceiver).

The display 110 is used to present savings goals, savings plans, information requests, savings progress, and the like. For example, the display 110 can be used to present to customer 104 a spectrum of potential suboptimal savings plans and potential benefits for each plan. In this regard, the display 110 is communicably and operatively coupled to the input/output circuit 112 to provide a user interface for receiving and displaying information on the customer device 106.

The input/output circuit 112 is structured to receive and provide communication(s) to a user of the customer device 106. In this regard, the input/output circuit 112 is structured to exchange data, communications, instructions, etc., with an input/output component of the customer device 106. Accordingly, in one embodiment, the input/output circuit 112 includes an input/output device such as a display device, a touchscreen, a keyboard, and a microphone. In another embodiment, the input/output circuit 112 may include communication circuitry for facilitating the exchange of data, values, messages, and the like between an input/output device and the components of the customer device 106. In yet another embodiment, the input/output circuit 112 may include machine-readable media for facilitating the exchange of information between the input/output device and the components of the customer device 106. In still another embodiment, the input/output circuit 112 may include any combination of hardware components (e.g., a touchscreen), communication circuitry, and machine-readable media.

The client application 114 is communicably coupled to the financial institution computing system 122 (e.g. input management processing circuit 138) via the network 120 and can be structured to manage communication with customer 104 with regard to developing and implementing a savings plan. In this regard, the client application 114 may provide displays indicative of a savings goal, a spectrum of potential suboptimal savings plans, an accepted suboptimal savings plan, progress of meeting a savings goal, profile information (e.g., contact information), and the like. Further, in some embodiments, the client application 114 may also permit a customer 104 to provide input with regard to a savings goals and/or plans. For example, client application 114 may provide a spectrum of potential suboptimal savings plans and potential outcomes associated with each plan. In some embodiments, the client application 114 allows the customer 104 to selectively indicate a parameter or requirement for a savings plan, indicate a personal interest of the customer 104, to eliminate a proposed savings plan, and/or to accept a desirable savings plan. In some embodiments, client application 114 is not provided.

Still referring to FIG. 1, the financial institution computing system 122 is associated with the financial institution 102. The financial institution 102 may be, for example, a credit card issuer, a bank, or the like. The financial institution computing system 122 includes a processing circuit 126 having a processor 128 and a memory 130. The processor 128 may be implemented as a general-purpose processor, an application specific integrated circuit (ASIC), one or more field programmable gate arrays (FPGAs), a digital signal processor (DSP), a group of processing components, or other suitable electronic processing components. The memory 130 may include one or more memory devices (e.g., RAM, NVRAM, ROM, Flash Memory, hard disk storage, etc.) and may store data and/or computer code for facilitating the various processes described herein. Moreover, the memory 130 may be or include tangible, non-transient volatile memory or non-volatile memory. Accordingly, the memory 130 may include database components, object code components, script components, or any other type of information structure for supporting the various activities and information structures described herein.

The financial institution computing system 122 further includes a network interface 124, which is used to establish connections with other components of the system 100 by way of network 120. The network interface 124 includes program logic that facilitates connection of the financial institution computing system 122 to the network 120. The network interface 124 supports communication between the financial institution computing system 122 and other systems, such as the customer device 106. For example, the network interface 124 includes a cellular modem, a Bluetooth transceiver, a Bluetooth beacon, a radio-frequency identification (RFID) transceiver, and a near-field communication (NFC) transmitter. In some embodiments, the network interface 124 communicates via a secured wired connection within a branch of the financial institution 102. In some arrangements, the network interface 124 includes the hardware and machine-readable media sufficient to support communication over multiple channels of data communication. Further, in some arrangements, the network interface 124 includes cryptography capabilities to establish a secure or relatively secure communication session with the financial institution computing system 122. In this regard, financial data (or other types of data) may be encrypted and transmitted to prevent or substantially prevent the threat of hacking.

The financial institution computing system 122 includes a financial strategy database 132. The financial strategy database 132 can be configured to hold, store, categorize, and otherwise serve as a repository for information associated with development and implementation of savings plans. The financial strategy database 132 is structured to selectively provide access to any information stored therein. In this regard, as discussed further herein, the financial strategy database 132 is communicably and operatively coupled to the input management processing circuit 136 and/or the financial strategy management processing circuit 138 such that the system 100 may facilitate development and implementation of a suboptimal savings plan.

In some arrangements, the financial strategy database 132 is structured to store information relating to development of a suboptimal savings plan. In this regard, financial strategy database 132 can be structured to store information relating to a savings goal, an optimal savings plan, and a suboptimal savings plan. For example, the financial strategy database 132 can store information relating to questions or prompts for identifying a savings goal of customer 104. Financial strategy database 132 can also store responses provided by customer 104 using customer device 106. In an example embodiment, stored information relates to savings plans that are or were proposed, attempted, unsuccessful, successful, optimal, suboptimal, active, etc. In an example embodiment, stored information also relates to parameters or requirements for a particular plan, various consequences (e.g. potential savings after a time period), personal interests and the like. In another example embodiment, financial strategy database 132 also stores information relating to various priorities associated with the spectrum of potential suboptimal savings plans. For example, customer 104 using customer device 106 can selectively assign a priority or rank for a potential suboptimal saving plan based on desirability.

In some arrangements, financial strategy database 132 is structured to store information automatically provided by customer 104 via customer device 106. In this regard, customer 104 using customer device 106 can provide information to financial strategy database 132 without directly interacting with a user interface of customer device 106 (e.g. client application 114). For example, it may be desirable to customer 104 to share location information of the customer device 106 (e.g. using GPS, triangulation). In this regard, financial strategy database 132 can be structured to store location information of customer device 106 and associated time values.

In some arrangements, financial strategy database 132 is structured to store global information relating to a characteristic of a group of customers or individuals. For example, global information can relate to a success rate corresponding to a particular savings plan previously provided to one or more individuals. In embodiments, global information can relate to any number of characteristics among any group of individuals, as well as any correlation among characteristics. For example, financial strategy database 132 may store global information relating to a success rate of a particular savings plan attempted by a group of adults under the age of 40, a success rate of the savings plan attempted by a group of adults residing within a particular geographical area, and a success rate of the savings plan attempted by a group of adults that are both under the age of 40 and residing within the particular geographical area.

In some arrangements, the financial strategy database 132 is further structured to store information relating to implementation of the accepted suboptimal savings plan. For example, implementation information can involve an identification of an active or accepted suboptimal savings plan of a set of potential suboptimal savings plans. In this regard, the financial strategy database 132 may set a flag or otherwise indicate in stored data that the savings plan is the active plan.

In some embodiments, implementation information stored by the financial strategy database 132 includes information relating to a monitoring program. A monitoring program can involve periodically receiving information associated with progress of the active plan, such as a savings account balance of customer 104. The monitoring program can compare the received savings account balance to a projected savings account balance. Various responsive actions or instructions can also be stored in the financial strategy database 132. For example, a responsive action can include a notification to customer 104 via customer device 106. Notifications may indicate overall progress, undesirable or desirable trends, suggestions, alerts and/or alternative savings plans. In this regard, financial strategy database 132 may store information relating to received savings account balances, projected savings account balances, and responsive actions. Stored information relating to the monitoring program can include credit card transactions, location information, and any information or data for facilitating implementation of suboptimal savings plans.

The financial institution computing system 122 further includes an account information database 134. The account information database 134 can be configured to hold, store, categorize, and otherwise serve as a repository for information associated with accounts held by financial institution 102, as well as any other financial information. The account information database 134 is structured to selectively provide access to financial information and any other information stored therein. In this regard, as discussed further herein, the account information database 134 is communicably and operatively coupled to the input management processing circuit 136 and/or financial strategy management processing circuit 138 such that the system 100 may facilitate development and implementation of a savings plan. Although shown as being part of the memory 130, in some arrangements account information database 134 is a separate component of the financial institution computing system 122.

In some arrangements, the account information database 134 stores financial information relating to accounts of customer 104, such as savings accounts, checking accounts, investment accounts, debit card transactions, credit card transactions, and the like. The account information database 134 may further store information regarding financial obligations of customer 104, such as monthly rent, mortgage utility bills, loans, and the like. In some embodiments, the account information database 134 stores global information relating to a group of individuals. For example, account information database 134 may store an average monthly utility bill payment associated with a group of individuals in a particular geographic location.

The financial institution computing system 122 includes an input management processing circuit 136 and a financial strategy management processing circuit 138. Although FIG. 1 shows the input management processing circuit 136 and the financial strategy management processing circuit 138 as part of the processing circuit 126, in other arrangements one or both of the input management processing circuit 136 and the financial strategy management processing circuit 138 are embodied as separate processing circuits. Other arrangements may include more or fewer circuits without departing from the spirit and scope of the present disclosure. Further, some arrangements may combine the activities of one circuit with another circuit to form a single circuit. Therefore, those of ordinary skill in the art will appreciate that the present arrangement is not meant to be limiting.

The input management processing circuit 136 is generally structured to process requests from financial strategy management circuit 138 to gather information relating to development and implementation of a suboptimal savings plan for subsequent processing by the financial strategy management circuit 138. In this regard, the input management processing circuit 136 can generally facilitate interaction with customer 104 via customer device 106. For example, input management processing circuit 136 can be structured to receive questions from the financial strategy management circuit 138 and/or financial strategy database 132. Input management processing circuit 136 can be structured to subsequently pass the questions to customer 104 via customer device 106, receive responses provided by customer 104, and store the received responses in the financial strategy database 132.

In one example embodiment, input management processing circuit 136 is configured to facilitate development of an optimal savings plan and a spectrum of suboptimal savings plan through a series of questions transmitted to customer 104 via client application 114 of customer device 106. The series of questions may involve a savings goal (e.g. sum of money saved, timeline), risk tolerance, a current savings account balance, income stream, debt obligations, reoccurring costs, spending prioritization, etc. In some embodiments, input management processing circuit 136 is structured to also receive information from other sources, such as account information database 134. For example, rather than asking customer 104 via customer device 106 about a current savings account balance, it may be desirable to customer 104 for input management processing circuit 138 to directly retrieve necessary information from account information database 134.

In some embodiments, the input management processing circuit 136 is also structured to facilitate implementation of a suboptimal savings plan. This can be achieved by continuously monitoring progress of a suboptimal savings plan, interacting with customer 104 via customer device 106, and/or otherwise gathering input information related to implementation of the suboptimal savings plan. For example, input management processing circuit 136 can be structured to periodically process requests to retrieve a current savings account balance from customer 104 via customer device 106 or from account information database 134. In response to the periodic requests, input management processing circuit 136 may transmit various notifications (e.g. stored in financial strategy database 132) to customer 104 via customer device 106. In this regard, input management processing circuit 136 can be structured to receive instructions from financial strategy management circuit 138 to gather information and subsequently pass the gathered information back to financial strategy management circuit 138 and/or store the gathered information in financial strategy database 132.

Still referring to FIG. 1, the financial strategy management processing circuit 138 is structured to facilitate and manage development and implementation of a potential suboptimal savings plan. In some arrangements, the financial strategy management processing circuit 138 is further structured to maintain financial strategy database 132 and account information database 134. In some arrangements, the financial strategy management processing circuit 138 is configured to develop a spectrum of potential savings plans using stored information in financial strategy database 132 and account information database 134. For example, financial strategy management processing circuit 138 can be configured to receive, from financial strategy database 132, information associated with responses relating to various questions transmitted to customer 104 via customer device 106, such as a savings goal and one or more acceptable methods of achieving that goal. The financial strategy management processing circuit 138 can also be configured to receive, from account information database 134, various financial information relating to checking or savings account balances, debit or credit card transactions, etc.

Upon receiving sufficient input information, financial strategy management processing circuit 138 is configured to analyze the received information to generate a spectrum of potential suboptimal savings plans to be proposed to the customer 104 via customer device 106. In some embodiments, the financial strategy management processing circuit 138 may also determine potential consequences associated with the generated suboptimal savings plans, such as a projected savings balance after a period of time. The financial strategy management processing circuit 138 can pass generated suboptimal savings plans and other information to financial strategy database 132 for storage and/or input management processing circuit 138 for communication with customer 104 through customer device 106. In this regard, the financial strategy management processing circuit 138 may store data in the financial strategy database 132 and instruct input management processing circuit 138 to retrieve the stored data. Input management processing circuit 138 may subsequently use the stored data to interact with customer 104 via customer device 106 to, for example, determine the suitability of a suboptimal savings plan.

In some arrangements, the financial strategy management processing circuit 138 is also structured to facilitate monitoring progress of a savings goal. In an embodiment, financial strategy management circuit 138 provides instructions to input management processing circuit 136 to implement a monitoring plan stored in financial strategy database 132. For example, a monitoring plan may involve input management processing circuit 136 periodically receiving a savings account balance from account information database 134 to determine progress of a suboptimal savings plan. Financial strategy management circuit 138 can be structured to instruct input management processing circuit 136 to gather any input information from any source, and store gathered information in the financial strategy database 132. In some embodiments, the financial strategy management circuit 138 is configured to receive and process stored information, and in response, take various actions. For example, when the financial strategy management processing circuit 138 determines that progress of a suboptimal savings plan is insufficient, it can be configured to provide a notification to customer 104 using customer device 106.

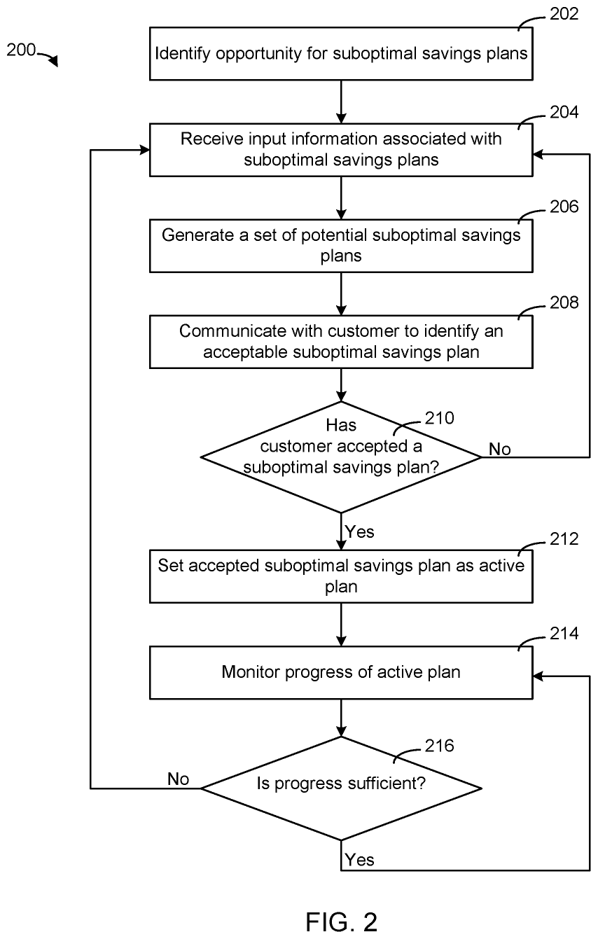

Referring to FIG. 2, a flow diagram of a method 200 for negotiating suboptimal savings is shown according to an example embodiment. The method 200 is performed by the financial institution computing system 122 (e.g., via the input management processing circuit 136 and the financial strategy management processing circuit 138). Through the method 200, the financial institution computing system 122 allows customers (e.g., the customer 104) to develop and implement a suboptimal savings plan from a spectrum of potential suboptimal savings plans.

An opportunity for a suboptimal savings plan is identified at step 202. The opportunity for a suboptimal savings plan is identified by the financial institution computing system 122. In some arrangements, the opportunity is identified when the customer 104 notifies the financial institution computing system 122. The customer 104 may indicate a desire for a suboptimal savings plan rather than an optimal savings plan because, for example, the optimal plan is too difficult to implement. The suboptimal savings is a savings plan not designed to achieve maximum savings over a period of time, but will more likely be implemented by the plan holder. As a result, although the customer is not financially positioned as well as would be with the optimal savings plan, the customer is nevertheless in a better financial position than otherwise. In embodiments, the suboptimal savings plan can relate to increasing a balance of a financial account (e.g. a savings account), reducing a debt liability (e.g. a mortgage), or any other plan designed to achieve a financial goal (e.g. by increasing financial health).

In some arrangements, the opportunity is identified when the financial institution computing system 122 determines the customer 104 cannot or is unlikely to adhere to an optimal savings plan for reaching a particular savings goal. For example, the financial institution computing system 122 can be configured to periodically monitor a savings account balance associated with the optimal savings plan upon request by customer 104. In some embodiments, the financial institution computing system 122 can be configured to automatically receive information from customer 104 upon request. For example, customer 104 may indicate a desire to share geographic location of customer device 106. Financial institution computing system 122 can identify the opportunity for a suboptimal savings plan based on the automatically received information from customer 104, including the geographic location of customer device 106. For example, if an optimal savings plan relates to minimizing expenditures at a store, geographic distance between customer device 106 and the store can be monitored. When the distance is below a minimum threshold, financial institution computing system 122 may identify the opportunity for a suboptimal savings plan.

The method 200 includes a negotiation process in steps 204-210. At step 204, input information associated with a savings goal of a customer is received at the financial institution computing system 122. Input information generally relates to information for facilitating development of a spectrum of potential suboptimal savings plans to be provided to the customer 104 (i.e. at step 206). Input information can be received from the account information database 134 and/or customer 104 through customer device 106. For example, financial institution computing system 122 may receive information from account information database 134 relating to credit card or debit card transactions of customer 104. Financial institution computing system 122 can be structured to receive any type of information such as input or parameters for a savings plan, general interests, account balances, reoccurring or fixed costs (e.g. a customer's rent or mortgage payments, utility bills, various loan payments, and other financial obligations), and/or general financial information associated with a group of individuals (e.g. average monthly utility bill amount associated with individuals in a geographic location).

In some arrangements, input information can be received from customer 104 through customer device 106 in response to a series of questions provided by the financial institution computing system 122. In some embodiments, a particular question in the series of questions depends on one or more previous responses. For example, an initial question may relate to a general topic and subsequent questions can relate to ranking subtopics. In some embodiments, input information from customer 104 through customer device 106 can relate to information automatically provided to the financial institution computing system 122, such as location information associated with customer device 106.

At step 206, financial institution computing system 122 generates a set of potential suboptimal savings plans. The set of potential suboptimal savings plan can be generated using input information received at step 204. In some embodiments, the set is also generated based on global information relating to a characteristic of a group of individuals. For example, the global information can relate to a suboptimal savings plan associated with a high success rate of individuals with similar demographic characteristics (e.g. age, location). In some arrangements, the potential suboptimal savings plans are generated by the financial strategy management processing circuit 138.

In one example, financial institution computing system 122 may have identified at step 202 that customer 104 has donated to a religious institution. As a result, financial institution computing system 122 may ask a series of questions relating to periodic investments with religious entities. In this regard, even though the investment may not maximize performance of an investment portfolio (by not investing in higher performing funds, by not optimizing portfolio diversity, etc.), customer 104 may be incentivized to increase savings activity and thereby increase the overall size of the portfolio.

In another example, financial institution computing system 122 may have determined that customer 104 may be paying a sufficiently excessive utility bill. For example, financial institution computing system 122 can be configured to retrieve a monthly utility payment associated with the customer, and to retrieve global information relating to an average utility payment among individuals in within a geographic vicinity of customer 104. Financial institution computing system 122 can compare the customer payments and the global information to determine whether customer may be paying a sufficiently excessive utility bill. In response to the comparison, financial institution computing system 122 can develop and suggest a suboptimal savings plan designed to reduce monthly utility payments. For example, the suggested suboptimal savings plan can include replacement of a gas furnace, windows with better air seals, etc.

In some arrangements, the generated set of suboptimal savings plans is a spectrum of suboptimal savings plans, whereby each plan is designed to result in one of several potential savings balances after a time period. One end of the spectrum can conceptually represent a potential savings balance associated with an optimal savings plan, whereby the potential savings balance is maximized. The other end of the spectrum can conceptually represent a potential savings balance associated with minimal savings. Accordingly, the spectrum of potential suboptimal savings plan can include various suboptimal savings plans, whereby each plan is associated with a potential savings balance after a time period along the spectrum. In this regard, financial institution computing system 122 can interact with customer 104 to identify a savings plan that is likely to be implemented and improves the financial health of customer 104.

At step 208, financial institution computing system 122 communicates with the customer 104 to identify an acceptable suboptimal savings plan. In some arrangements, the input management processing circuit 136 manages the communication. In some embodiments, the communication involves a sequence of questions and answers with customer 104 using client application 114 of customer device 106. For example, input management processing circuit 136 can be configured to provide one or more questions to customer 104 through client application 114 and to receive responses provided by customer 104.

In one example embodiment, financial institution computing system 122 may indicate to customer 104 that abstaining from a daily expense at a coffee house can result in a particular increase in savings. Financial institution computing system 122 may ask whether customer 104 is willing to forego the daily expenditure and allocate a sum of money corresponding to the saved money to savings, such as through a monthly transfer to a designated savings account. Alternatively or additionally, for example, financial institution computing system 122 may ask whether customer 104 is willing to reduce the daily expenditure by a particular percentage amount. Financial institution computing system 122 can be configured to provide a potential financial benefit corresponding to each suboptimal savings plan. If the customer 104 does not accept the offered plan, financial institution computing system 122 can be configured to continue the negotiation process by asking whether one or more other suboptimal savings plans are acceptable. For example, financial institution computing system 122 may offer a suboptimal plan suggesting a less-expensive coffee house or a coffee machine the customer can use at home to spend less and save money.

In some arrangements, financial institution computing system 122 may be configured to provide a sequence of questions during the negotiation process such that each successive question in the sequence corresponds to a potential suboptimal savings plan designed to achieve a lower projected savings balance. Thus, for example, a first question to customer 104 may ask whether the customer is willing to completely forego a daily expense at a coffee house. A subsequent question can relate to whether the customer is willing to visit the coffee house less often, such as twice per week. Another subsequent question can relate to whether the customer is willing to visit the coffee house five times per week. Another subsequent question can relate to whether the customer is willing to reduce the daily expenditure amount at the coffee house by a particular percentage, and so on.

In some embodiments, the sequence of questions during the negotiation process can be configured such that each successive question is based on criteria in addition to movement along the savings spectrum. For example, questions can relate to a suboptimal savings plan associated with an interest or preference of customer 104, or any other relevant information. For example, during step 204, customer 104 may have indicated an interest relating to a religious entity. Financial institution computing system 122 may offer one or more suboptimal savings plans relating to a periodic investment or donation with a religious entity to entice customer 104 to increase savings activity. If the customer 104 does not accept the offered plan, financial institution computing system 122 may offer another suboptimal savings plan relating to a religious activity (e.g. a lower investment or donation amount), or a suboptimal savings plan relating to another interest or preference of customer 104.

In some embodiments, any combination or sequence of questions can be provided to user 104 via customer device 106. In some arrangements, after a first question, financial institution computing system 122 is configured to only provide a subsequent question after customer 104 provides a response to the first question (e.g. via customer device 106). In other arrangements, financial institution computing system 122 can be configured to provide the first question and one or more subsequent questions without requiring the customer 104 to first provide a response to the first question.

In some arrangements, when the customer 104 accepts a suboptimal savings plan, the financial institution computing system 122 can be configured to either continue to step 210 or continue the negotiation process. For example, financial institution computing system 122 may be configured to continue the negotiation process until a minimum threshold of potential savings is reached. In other embodiments, financial institution computing system 122 may additionally or alternatively identify several options of potential suboptimal savings and may negotiate one or more options. In this regard, two or more suboptimal savings plans can be consolidated into one comprehensive suboptimal savings plan that includes each accepted suboptimal saving plan. In some arrangements, financial institution computing system 122 stores an accepted suboptimal savings plan in the financial strategy database 132.

At step 210, financial institution computing system 122 determines whether a suboptimal savings plan has been accepted at step 208. In some embodiments, the financial strategy management processing circuit 138 performs step 210. For example, financial strategy management circuit 138 may query financial strategy database 132 to determine whether a suboptimal savings plan has been accepted and to identify the particular suboptimal savings plan. If the customer 104 has accepted a suboptimal savings plan, the financial institution computing system 122 continues to step 212.

If the customer 104 has not accepted a suboptimal savings plan, then the method 200 returns to step 204 to restart the negotiation process. In this regard, the financial institution computing system 122 can initiate a new series of questions, which may depend on information previously received and/or information obtained from additional sources. For example, financial institution computing system 122 may query financial strategy database 132 for global information relating to acceptance rates of suboptimal savings plans among a group of individuals. In this example, financial strategy database 132 can be configured to store data associated with one or more suboptimal savings plans that correspond to a high acceptance rate of customers with one or more characteristics of customer 104 (e.g. age, geographic area, etc.). In this regard, repeated step 204 can involve gathering input information from customer 104 to identify one or more characteristics that correspond to a group of adults that attempted a suboptimal savings plan with a high success rate. Financial institution computing system 122 may subsequently generate a second set of potential suboptimal savings plans at step 206. Accordingly, steps 204-210 can be repeated until acceptance of a suboptimal savings plan is negotiated with customer 104.

At step 212, the accepted suboptimal savings plan is set as an active plan by the financial institution computing system 122. In some arrangements, the financial strategy management circuit 138 instructs the financial strategy database 132 to retrieve the generated set of potential suboptimal savings plans and flag the accepted suboptimal savings plan as the active plan in stored data of the financial strategy database 132. In this regard, the financial institution computing system 122 (e.g. input management processing circuit 136) can be configured to readily identify the active plan during subsequent interactions with the customer 104.

At step 214, financial institution computing system 122 monitors progress of the active plan. In some arrangements, the financial strategy management circuit 138 generates and stores a monitoring plan in the financial strategy database 132. The monitoring plan can include a projected savings schedule that includes projected savings balances over a series of time intervals. For example, the projected savings schedule can include a projected three percent savings increase after one month, a projected six percent savings increase after two months, and so on. Embodiments may use any series of time intervals.

In some arrangements, financial institution computing system 122 (e.g. input management processing circuit 136) monitors progress by periodically evaluating a running balance of a designated savings account associated with customer 104. In this regard, the running balance for the designated savings account can be stored in account information database 134. Financial institution computing system 122 can be configured to query the account information database 134 to retrieve the balance at a time period corresponding to the series of time intervals or according to a particular formula. Financial institution computing system 122 can be configured to subsequently store the balance in the financial strategy database 132 and take any other action to facilitate implementation of the active savings plan.

In some arrangements, financial institution computing system 122 is configured to determine whether progress of the monitoring plan is sufficient by periodically retrieving a balance of the designated savings account and comparing the retrieved balance to a corresponding value in the projected savings schedule. Referring to the example savings schedule above, after one month financial institution computing system 122 can retrieve the running balance and compare the retrieved balance to a savings schedule value corresponding to a three percent increase. If the retrieved balance is below the savings schedule value, then financial institution computing system 122 can be configured to determine the savings progress is insufficient. If the retrieved balance is above the compared value, then financial institution computing system 122 can be configured to determine the savings progress is sufficient. Financial institution computing system 122 can be configured to repeat the comparison process after the second month to determine whether the running balance of the designated savings account corresponds to a six percent increase.

In some arrangements, when the progress of the monitoring plan is determined to be insufficient, the process 200 is configured to return to step 204 to receive input information. In this regard, process 200 can repeat the negotiation process of steps 204-210 to identify another suboptimal savings plan. For example, financial institution computing system 122 may query financial strategy database 132 for global information relating to acceptance rates of suboptimal savings plans among a group of individuals. In this example, financial strategy database 132 can be configured to store data associated with one or more suboptimal savings plans that correspond to a high acceptance rate of customers with one or more characteristics of customer 104 (e.g. age, geographic area, etc.). In this regard, step 204 of process 200 can involve gathering input information from customer 104 to identify one or more characteristics that correspond to a group of adults that attempted a suboptimal savings plan with a high success rate. Financial institution computing system 122 may subsequently generate a second set of potential suboptimal savings plans at step 206.

In some embodiments, financial institution computing system 122 (e.g. financial strategy management circuit 138) is configured to dynamically adjust the monitoring plan, including the projected savings schedule. Financial institution computing system 122 can dynamically adjust the monitoring plan according to one or more parameters after each time interval. In an embodiment, a parameter is sufficiency of progress. Referring to the above example, if the three percent savings balance is not met after the first month, financial institution computing system 122 can revise the savings schedule such that the projected savings balance after two or more months is marginally decreased. In this regard, the projected balance after two months may decrease by an amount corresponding to a balance deficit of the first month. The financial institution computing system 122 can be configured to revise projected balances corresponding to any number of time intervals and/or store the revised monitoring plan in the financial strategy database 132.

In some arrangements, the financial institution computing system 122 is configured to take a responsive action based on progress of the active savings plan. A responsive action can include a notification to customer 104 indicating sufficient progress or insufficient progress according to the monitoring plan. Referring to the above example, if the retrieved savings balance exceeds the value in the savings schedule corresponding to a three percent increase, financial institution computing system 122 can be configured to provide a notification with congratulatory text and/or pictures relating to customer 104 on reaching a particular milestone. If the retrieved savings balance did not exceed the value corresponding to a three percent increase, the notification can relate to an alert with text and/or pictures indicating that customer 104 has not reached a particular milestone.

In embodiments, notifications to customer 104 can include any combination of text and/or pictures and can be communicated through any suitable interface. For example, a notification can be a text message sent by financial institution computing system 122 to customer device 106 with text that relates to encouraging the customer 104 to continue progress. As another example, a notification can be provided through client application 114 of customer device 106 with text and pictures describing additional instructions for increasing progress.

In some arrangements, a responsive action can be tailored to particular input information. In an example embodiment, an active plan may involve reducing expenditures at a coffee house, and information stored in the account information database 134 indicates that customer 104 has not adequately followed the plan (e.g. a savings balance is below a threshold and credit card transactions indicate daily expenditures at the coffee house). In this situation, financial institution computing system 122 may be configured to receive location information of customer 104 using customer device 106. Financial institution computing system 122 can use the location information to identify when customer 104 is likely to make an expenditure at the coffee house, by, for example, comparing a distance between customer device 106 and the coffee house. In response to the determination, the financial institution computing system 122 can be configured to trigger an alert to the customer device 106. The alert may, for example, provide an incentive to customer 104 to not make the expenditure, such as by including an estimate of potential savings if the customer 104 returns to the active plan.

At step 216, the financial institution computing system 122 determines whether progress of the active plan is sufficient. In some arrangements, financial institution computing system 122 compares a balance of a designated savings account to a corresponding value in a savings schedule of a monitoring plan, such as described above. In some embodiments, financial institution computing system 122 (e.g. financial strategy management circuit 138) is configured to retrieve information relating to the designated savings account from account information database 134 and information relating to the savings schedule from the financial strategy database 132. In some arrangements, when financial institution computing system 122 determines progress is sufficient, the process returns to step 214 to continue monitoring progress. When financial institution computing system 122 determines progress is insufficient, the method 200 returns to step 204 and the negotiation process of steps 204-210 can be repeated to determine a suitable suboptimal savings plan. In this regard, financial institution computing system 122 can be configured to modify information stored in financial strategy database 132 associated with the active plan, including the monitoring plan and the savings schedule.

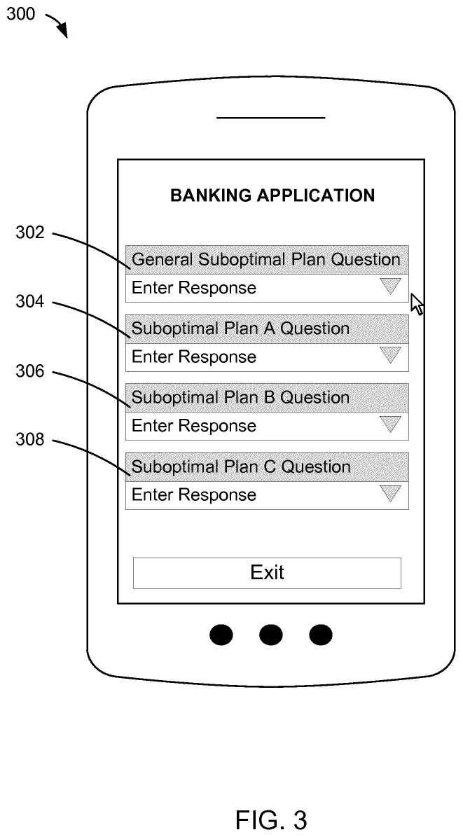

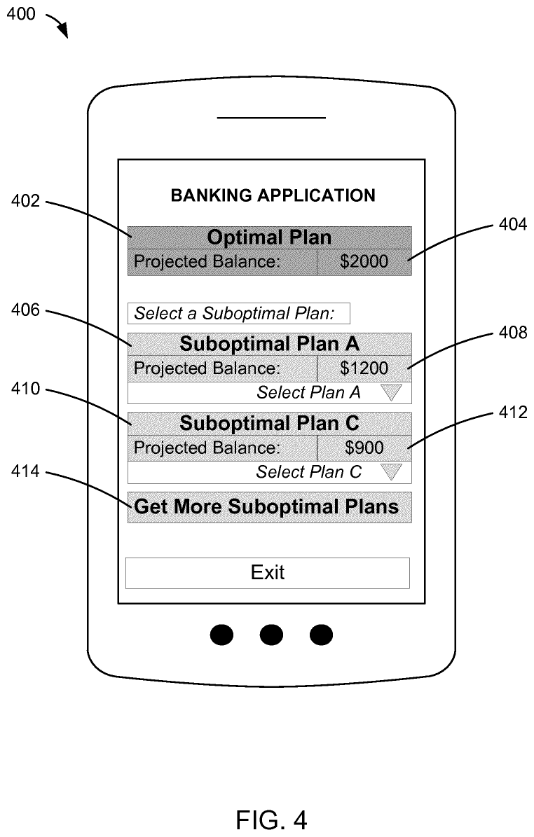

Referring to FIGS. 3-4, various user interfaces of a banking application displayed by the system 100 are shown, according to example embodiments. The user interfaces may be displayed to the customer 104 on the customer device 106 through the client application 114. In some embodiments, the financial institution computing system 122 first authenticates the customer 104 through the client application 114. For example, before customer 104 can access user interfaces shown in FIGS. 3-4, financial institution computing system 122 may first prompt customer 104 to provide a password or a token.

Referring to FIG. 3, a user interface 300 shows a set of questions 302-308 for gathering input information from customer 104. In some embodiments, the set of questions 302-308 is configured by input management processing circuit 136. User interface 300 allows customer 104 to provide one or more responses to the set of questions 302-308, which may be used by financial institution computing system 122 to subsequently generate a set of potential suboptimal savings plans. In some embodiments, the set of questions 302-308 corresponds to step 204 and/or step 208 of method 200.

The set of questions 302-308 in user interface 300 includes a general question 302 and questions relating to potential suboptimal savings plans 304-308. In some embodiments, user interface 300 can include any variation or combination of questions. For example, user interface 300 can be configured to only include one question, such as general question 302. In other embodiments, user interface 300 can include a set of general questions and/or a set of questions relating to a potential suboptimal savings plan.

General question 302 can relate to any topic for facilitating development and/or implementation of a suboptimal savings plan. For example, general question 302 can relate to a general savings goal and/or general requirements of a savings plan, such as a timeline for achieving the savings goal. As another example, general question 302 can relate to an interest or hobby of customer 104. In some embodiments, general question 302 can relate to a request for authorization, such as a request to authorize financial institution computing system 122 to automatically receive information relating to a savings account balance of customer 104.

Questions relating to potential suboptimal savings plans 304-308 can generally be configured to relate to one or more suboptimal savings plans. For example, potential suboptimal savings plan question 304 can relate to saving money on a monthly utility bill. In this regard, question 304 can relate to a monthly payment amount associated with the utility bill. As another example, question 304 can relate to whether customer 104 is willing to purchase a new appliance, such as an efficient gas furnace, to facilitate saving money on the monthly utility bill. Question 304 can also relate to whether customer 104 is willing to setup a periodic transfer to a designated savings account of customer 104.

In some arrangements, one or more questions 302-308 of interface 300 can be configured based on received input information. In some arrangements, user interface 300 can be configured to only include an initial set of general questions, and financial institution computing system 122 is configured to first receive responses to the initial set and then configure a subsequent set of questions based on received input information relating to the initial set. For example, the initial set of general questions can relate to general interests of customer 104, and the subsequent set can relate to a ranking or priority of the general interests. As another example, the subsequent set of questions can include questions relating to one or more potential suboptimal savings plans, whereby the subsequent set is configured based on responses to the initial set of general questions.

Referring to FIG. 4, a user interface 400 is provided relating to identifying a potential suboptimal savings plan that the customer 104 will implement. In some embodiments, user interface 400 corresponds to step 208 of method 200. User interface 400 is generally configured to enable customer 104 to select a potential suboptimal savings plan for implementation. For example, user interface 400 may include a touch-sensitive button for selecting a first suboptimal savings plan 406 and a touch-sensitive button for selecting a second suboptimal savings plan 410 for implementation. In some embodiments, the suboptimal savings plans 406 and 410 are generated based on received input information provided through interface 300. For example, received input information provided through interface 300 may include a requirement of customer 104, whereby only suboptimal savings plans associated with questions 304 and 308 meet the requirement. In this regard, user interface 400 is shown to only include information relating to the suboptimal savings plans associated with questions 304 and 308.

User interface 400 can be configured to include any combination of text, pictures, and/or touch-sensitive buttons to facilitate identifying a potential suboptimal savings plan that customer 104 will implement. For example, user interface 400 is shown to include a projected balance 408 associated with the first suboptimal savings plan 406 and a projected balance 412 associated with the second suboptimal savings plan 410. User interface 400 is shown to also include a projected balance 404 associated with optimal savings plan 402. In this regard, user interface 400 can be configured to allow customer 104 to efficiently compare one or more suboptimal savings plans, and compare the suboptimal savings plans with the optimal savings plan. User interface 400 is shown to also include a button 414 allowing customer 104 to selectively access another interface (e.g. interface 300), which may include another set of questions to customer 104 relating to other potential suboptimal savings plans.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more dedicated processors communicatively coupled to one or more dedicated memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc.

An example system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A financial institution computing system associated with a financial institution, the system comprising:
a network interface structured to facilitate data communication via a network;
a financial strategy database structured to store information associated with an optimal savings plan and at least one suboptimal savings plan;
an account information database structured to store information associated with a financial account held by a customer; and
a processing circuit comprising a processor and a memory, the processing circuit structured to perform a negotiation process with the customer, wherein the negotiation process comprises:
generating an optimal savings plan for the customer, wherein the optimal savings plan is associated with at least one of maximizing a savings balance for the customer after a time period or generating a savings balance for a financial goal of the customer after the time period;
monitoring a savings account balance of the customer;
determining that the customer cannot or is unlikely to adhere to the optimal savings plan based on the monitored savings account balance;
identifying an opportunity for a suboptimal savings plan relating to the customer based on the determination that the customer cannot or is unlikely to adhere to the optimal savings plan;
receiving information associated with the financial account held by the customer, wherein the information comprises customer device data automatically received by the processing circuit, and wherein the customer device data comprises geolocation data of the customer indicative of a geographic area of the customer;
determining a characteristic associated with a group of individuals that previously attempted particular savings plans, wherein the group of individuals are associated with the geographic area of the customer, wherein the characteristic comprises a success rate of the previously attempted particular savings plans;
generating a set of potential suboptimal savings plans based on the received information and the characteristic, wherein each of the potential suboptimal savings plans is associated with generating a suboptimal savings balance that is less than the at least one of the maximized savings balance or the financial goal savings balance of the optimal savings plan after the time period;
providing to the customer, via a device of the customer, the set of potential suboptimal savings plans;
receiving, from the device of the customer, a customer selection of one of the potential suboptimal savings plans;
setting the selected suboptimal savings plan as an active savings plan in response to receiving the customer selection;
monitoring the progress of the active savings plan based on periodically receiving information associated with transactions of the customer and corresponding locations of the customer;
determining that the customer is likely to make an expenditure contrary to the active saving plan based on the monitoring identifying a location of the customer device relative to a location of a merchant where the customer has previously made an expenditure; and
transmitting a notification to the customer device, the notification comprising an incentive for the customer if the customer does not make the expenditure, wherein the incentive comprises an estimate of potential savings associated with the active savings plan should the customer not make the expenditure.

2. The system of claim 1, wherein the financial account includes at least one of: the savings account, a checking account, an investment account, a debit card account, a credit card account, or a utility bill.

3. The system of claim 1, wherein the processing circuit is further configured to receive information associated with an average value of accounts held by a group of individuals.

4. The system of claim 3, wherein the average value of accounts corresponds to an average value of utility bill accounts.

5. The system of claim 1, wherein the processing circuit is further configured to receive information relating to at least one interest of the customer.

6. The system of claim 1, wherein the selected suboptimal savings plan is the active savings plan for the savings account, and wherein monitoring the progress of the active savings plan further comprises receiving a balance of the savings account and comparing the savings account balance to a predetermined projected account balance threshold, and communicating, to the customer, information relating to the progress of the active savings plan.

7. The system of claim 6, wherein the communicated information relates to a notification indicating insufficient progress of the active savings plan based on the savings account balance being below the predetermined projected account balance threshold.

8. The system of claim 6, wherein the communicated information relates to a notification indicating sufficient progress of the active savings plan based on the savings account balance being above the predetermined projected account balance threshold.

9. The system of claim 1, wherein:
the set of suboptimal savings plans includes a first suboptimal savings plan configured to generate a first suboptimal savings balance after the time period and a second suboptimal savings plan configured to generate a second suboptimal savings balance after the time period; and
a value of the first suboptimal savings balance after the time period is greater than a value of the second suboptimal savings balance after the time period.

10. The system of claim 9, wherein communicating the set of potential suboptimal savings plans comprises:
communicating, with the customer, the first suboptimal savings plan; and
communicating, with the customer, the second suboptimal savings plan based on the first suboptimal savings plan not being accepted.

11. The system of claim 10, wherein, in response to the second suboptimal savings plan not being accepted, the processing circuit is configured to repeat the negotiation process.

12. A method for negotiating a suboptimal savings plan comprising:
generating by a financial institution computing system, an optimal savings plan for the customer, wherein the optimal savings plan is associated with at least one of maximizing a savings balance for the customer after a time period or generating a savings balance for a financial goal of the customer after the time period;
monitoring, by the financial institution computing system, a savings account balance of the customer;
determining, by the financial institution computing system, that the customer cannot or is unlikely to adhere to the optimal savings plan based on the monitored savings account balance;
identifying, by the financial institution computing system, an opportunity for a suboptimal savings plan relating to a customer based on the determination that the customer cannot or is unlikely to adhere to the optimal savings plan;
receiving, by the financial institution computing system, information associated with a financial account held by the customer, wherein the information comprises customer device data automatically received by the processing circuit, and wherein the customer device data comprises geolocation data of the customer indicative of a geographic area of the customer;
determining, by the financial institution computing system, a characteristic associated with a group of individuals that previously attempted particular savings plans, wherein the group of individuals are associated with the geographic area of the customer, wherein the characteristic comprises a success rate of the previously attempted particular savings plans;
generating, by the financial institution computing system, a set of potential suboptimal savings plans based on the received information and the characteristic, wherein each of the potential suboptimal savings plans is associated with generating a suboptimal savings balance that is less than the at least one of the maximized savings balance or the financial goal savings balance of the optimal savings plan after the time period;
communicating, by the financial institution computing system, the set of potential suboptimal savings plans with the customer;
receiving, by the financial institution computing system, a customer selection of one of the potential suboptimal savings plans;
setting, by the financial institution computing system, the selected suboptimal savings plan as an active savings plan in response to receiving the customer selection;
monitoring, by the financial institution computing system executing a monitoring program, the progress of the active savings plan based on periodically receiving information associated with transactions of the customer and corresponding locations of the customer;
determining, by the financial institution computing system, that the customer is likely to make an expenditure contrary to the active saving plan based on the monitoring program identifying a location of the customer device relative to a location of a merchant where the customer has previously made an expenditure; and
transmitting, by the financial institution computing system, a notification to the customer device, the notification comprising an incentive for the customer if the customer does not make the expenditure, wherein the incentive comprises an estimate of potential savings associated with the active savings plan should the customer not make the expenditure.

13. The method of claim 12, wherein the financial account includes at least one of: the savings account, a checking account, an investment account, a debit card account, a credit card account, or a utility bill.

14. The method of claim 12, wherein the financial institution computing system is further configured to receive information associated with an average value of accounts held by a group of individuals.

15. The method of claim 14, wherein the average value of accounts corresponds to an average value of utility bill accounts.

16. The method of claim 12, wherein the financial institution computing system is further configured to receive information relating to at least one interest of the customer.

17. The method of claim 12, wherein the selected suboptimal savings plan is the active savings plan for the savings account, and wherein monitoring the progress of the active savings plan further comprises receiving a balance of the savings and comparing the savings account balance to a predetermined projected account balance threshold, and communicating, to the customer, information relating to the progress of the active savings plan.

18. The method of claim 17, wherein the communicated information relates to a notification indicating insufficient progress of the active savings plan based on the savings account balance being below the predetermined projected account balance threshold.

19. The method of claim 17, wherein the communicated information relates to a notification indicating sufficient progress of the active savings plan based on the savings account balance being above the predetermined projected account balance threshold.

20. The method of claim 12, wherein:
the set of suboptimal savings plans includes a first suboptimal savings plan configured to generate a first suboptimal savings balance after the time period and a second suboptimal savings plan configured to generate a second suboptimal savings balance after the time period; and
a value of the first suboptimal savings balance after the time period is greater than a value of the second suboptimal savings balance after the time period.

21. The method of claim 20, wherein communicating the set of potential suboptimal savings plans comprises:
communicating, with the customer, the first suboptimal savings plan; and
communicating, with the customer, the second suboptimal savings plan based on the first suboptimal savings plan not being accepted.

22. An apparatus comprising:
a financial strategy management processing circuit included in a financial institution computing system associated with a financial institution, the financial strategy management processing circuit configured to:
generate an optimal savings plan for the customer, wherein the optimal savings plan is associated with at least one of maximizing a savings balance for the customer after a time period or generating a savings balance for a financial goal of the customer after the time period;
monitor a savings account balance of the customer;
determine that the customer cannot or is unlikely to adhere to the optimal savings plan based on the monitored savings account balance;
identify an opportunity for a suboptimal savings plan relating to a customer based on the determination that the customer cannot or is unlikely to adhere to the optimal savings plan;
receive information associated with a financial account held by the customer, wherein the information comprises customer device data automatically received by the processing circuit, and wherein the customer device data comprises geolocation data of the customer indicative of a geographic area of the customer;
determine a characteristic associated with a group of individuals that previously attempted particular savings plans, wherein the group of individuals are associated with the geographic area of the customer, wherein the characteristic comprises a success rate of the previously attempted particular savings plans;
generate a set of potential suboptimal savings plans based on the received information and the characteristic, wherein each of the potential suboptimal savings plans is associated with generating a suboptimal savings balance that is less than the at least one of the maximized savings balance or the financial goal savings balance of the optimal savings plan after the time period;
provide the customer with the set of potential suboptimal savings plans;
receive a customer selection of one of the potential suboptimal savings plans;
set the selected suboptimal savings plan as an active savings plan in response to receiving the customer selection
monitor the progress of the active savings plan based on periodically receiving information associated with transactions of the customer and corresponding locations of the customer;
determine that the customer is likely to make an expenditure contrary to the active saving plan based on the monitoring identifying a location of the customer device relative to a location of a merchant where the customer has previously made an expenditure; and
transmit a notification to the customer device, the notification comprising an incentive for the customer if the customer does not make the expenditure, wherein the incentive comprises an estimate of potential savings associated with the active savings plan should the customer not make the expenditure.

23. The apparatus of claim 22, wherein the financial account includes at least one of: the savings account, a checking account, an investment account, a debit card account, a credit card account, or a utility bill.

24. The apparatus of claim 22, wherein the financial strategy management processing circuit is further configured to receive information associated with an average value of accounts held by a group of individuals.

25. The apparatus of claim 24, wherein the average value of accounts corresponds to an average value of utility bill accounts.

26. The apparatus of claim 22, wherein the financial strategy management processing circuit is further configured to receive information relating to at least one interest of the customer.

27. The apparatus of claim 22, wherein the selected suboptimal savings plan is the active savings plan for the savings account, and wherein monitoring the progress of the active savings plan further comprises receiving a balance of the savings account and comparing the savings account balance to a predetermined projected account balance threshold, and communicating, to the customer information relating to the progress of the active savings plan.

28. The apparatus of claim 27, wherein the communicated information relates to a notification indicating insufficient progress of the active savings plan based on the savings account balance being below the predetermined projected account balance threshold.

29. The apparatus of claim 22, wherein:
the set of suboptimal savings plans includes a first suboptimal savings plan configured to generate a first suboptimal savings balance after the time period and a second suboptimal savings plan configured to generate a second suboptimal savings balance after the time period; and
a value of the first suboptimal savings balance after the time period is greater than a value of the second suboptimal savings balance after the time period.

30. The apparatus of claim 29, wherein communicating the set of potential suboptimal savings plans comprises:
communicating, to the customer, the first suboptimal savings plan; and
communicating, to the customer, the second suboptimal savings plan based on the first suboptimal savings plan not being accepted.
